(19) United States
(12) Patent Application Publication
(10) Pub. No.: US 2025/0062370 A1
(43) Pub. Date: Feb. 20, 2025

(54) BIPOLAR PLATE FOR A FUEL CELL STACK

(71) Applicant: Vitesco Technologies GmbH, Regensburg (DE)

(72) Inventors: Frank DIETRICH, Chemnitz (DE); Axel BÖLT, Chemnitz (DE); Ferdinand LÖBBERING, Alteglofsheim (DE); Andreas LUKASCH, Chemnitz (DE); Kay HÄLSIG, Burgstädt (DE); Steffen KUNZ, Chemnitz (DE)

(73) Assignee: Vitesco Technologies GmbH, Regensburg (DE)

(21) Appl. No.: 18/715,808

(22) PCT Filed: Dec. 1, 2022
(86) PCT No.: PCT/EP2022/084087

§ 371 Date: Jun. 3, 2024

(30) Foreign Application Priority Data
Dec. 14, 2021 (DE) 10 2021 214 297.4

(51) Int. Cl. H01M 8/0265; H01M 8/0267; H01M 8/2483

(52) U.S. Cl. CPC H01M 8/0265; H01M 8/0267; H01M 8/2483

(57) ABSTRACT

A fuel cell stack bipolar plate, includes two half-plates connected to one another and a flow space formed between the half-plates for distributing a coolant flowing into the flow space through an inlet hole of the bipolar plate, located on a first edge of the bipolar plate, and flows out of the flow space through an outlet hole of the bipolar plate, located on an opposite second edge of the bipolar plate, over the area of the bipolar plate's flow field. The flow field debouches at its ends facing toward the first and second edges of the bipolar plate into a distribution region connected to the respective hole. The distribution region includes a pre-distributing channel, which debouches into the respective hole, extends along a direction of the first and second edges of the bipolar plate and has a plurality of throttle apertures arranged distributed and face toward the flow field.

### CROSS REFERENCE TO RELATED APPLICATIONS

This application is the U.S. National Phase application of PCT International Application No. PCT/EP2022/084087, filed Dec. 1, 2022, which claims priority to German Patent Application No. 10 2021 214 297.4, filed Dec. 14, 2021, the contents of such applications being incorporated by reference herein.

### FIELD OF THE INVENTION

The present invention relates to a bipolar plate and to a fuel cell stack formed by using such bipolar plates.

### BACKGROUND OF THE INVENTION

A fuel cell stack according to the prior art is formed from a multiplicity of fuel cells arranged stacked in a stack direction, each of which has a plate-like geometrical configuration and, as seen orthogonally with respect to the stack direction, each of which extends in a first transverse direction and a second transverse direction orthogonal thereto. The individual fuel cells of a fuel cell stack typically have, respectively stacked in the stack direction:
an anode-side bipolar half-plate with a fuel channel structure for guiding a fuel,
an anode-side gas diffusion sheet,
a membrane-electrode assembly having an electrolyte membrane and electrode layers arranged on both sides thereof in the stack direction, which form an anode and a cathode for an electrochemical reaction of the fuel with an oxidant,
a cathode-side gas diffusion sheet,
a cathode-side bipolar half-plate with an oxidant channel structure for guiding the oxidant.

During operation of the fuel cell stack, the chemical energy of reaction of the fuel (for example hydrogen) and of the oxidant (for example oxygen or air) is converted into electrical energy by the electrochemical reaction.

In respect of the prior art of such fuel cell stacks, reference is made by way of example to the publications EP 2 357 698 B1, EP 2 445 045 B1, EP 2 584 635 B1, EP 2 946 431 B1 and EP 3 316 377 A1, each of which are incorporated herein by reference.

For the manufacture of a fuel cell stack, so-called “bipolar plates” are generally used, which are prefabricated from two (bipolar) half-plates that function during subsequent operation of the fuel cell stack as an anode-side half-plate of a fuel cell and as a cathode-side half-plate of a fuel cell directly adjacent in the stack.

A bipolar plate therefore constitutes a separator plate between fuel cells adjacent to one another in the stack, and is in this case used particularly for electrically connecting fuel cells next to one another in the stack and, in the case of a bipolar plate according to the preamble of claim 1, also to provide a defined flow space for guiding a coolant in the interior of the bipolar plate (between the half-plates), so that the fuel cells formed on both sides of the bipolar plate in the stack can be cooled, or thermally regulated.

A bipolar plate according to the preamble of claim 1 is known for example from the publication DE 10 2019 000 150 A1, incorporated herein by reference, and comprises:
two half-plates connected to one another,
an inlet hole located on a first edge of the bipolar plate and an outlet hole located on an opposite second edge of the bipolar plate,
a flow space formed between the half-plates for distributing a coolant over the area of a flow field of the bipolar plate when the coolant flows into the flow space through the inlet hole and out of the flow space through the outlet hole, the flow field debouching at its ends facing toward the first and second edges of the bipolar plate into a distribution region connected to the respective hole.

The term “flow field” refers in general to that region, as seen in the plane of the bipolar plate, in which the electrochemical reaction of the continuously supplied fuel (for example hydrogen) with the continuously supplied oxidant (for example oxygen or air) takes place during operation of the fuel cells.

The “distribution region” therefore constitutes a separating region of the flow space, which is arranged between on the one hand an assigned hole (inlet hole or outlet hole) and on the other hand an assigned one of the two ends of the flow field.

Considered in terms of flow technology, the two distribution regions of the bipolar plate are therefore used to “distribute” the coolant inlet flow coming from the inlet hole over the width of the flow field, and respectively to “collect” a coolant outlet flow there coming from the flow field over the width of the outlet hole, specifically so that a desired flow of coolant through the flow field, which is generally as uniform as possible, is achieved. Since the area available for the distribution regions is limited in practice, the function of such distribution regions is often not entirely satisfactory.

The individual known features described so far of fuel cell stacks and bipolar plates may also be provided in the present invention described below.

### SUMMARY OF THE INVENTION

An aspect of the present invention aims to provide a novel way in which a particularly precise and in particular uniform distribution of the coolant over the area of the flow field can be achieved in a bipolar plate of the type mentioned in the introduction, in particular even in the case of a distribution region requiring relatively little area.

The bipolar plate according to an aspect of the invention is characterized in that the distribution region comprises a pre-distributing channel, which debouches into the respective hole, extends along a direction of the first and second edges of the bipolar plate and has along its profile a plurality of throttle apertures (openings) that are arranged distributed and face toward the flow field.

The direction of the aforementioned first and second edges of the bipolar plate will also be referred to below as the “transverse direction” of the bipolar plate, and the direction orthogonal to the transverse direction lying in the plane of the bipolar plate will also be referred to below as the “longitudinal direction” of the bipolar plate. The direction orthogonal to the plane of the bipolar plate will be referred to as the “vertical direction”.

The “pre-distributing channel” may be regarded as a subregion, elongated in the transverse direction, of the flow space and in this case especially as an elongated subregion of the distribution region which, considered in terms of flow technology, is arranged between on the one hand an assigned hole (inlet hole or outlet hole) and on the other hand a remaining part of the relevant distribution region, for example geometrically configured in a conventional way.

Since the pre-distributing channel debouches into the respective hole, coolant coming from the inlet hole can flow directly into the inlet-side pre-distributing channel and can flow out from the outlet-side pre-distributing channel directly into the outlet hole. The pre-distributing channel may, for example, debouch into the relevant (assigned) hole through a single connecting passage or opening (with a relatively large cross section) or through a plurality of (for example from 2 to 30) connecting passages arranged in parallel with one another in terms of flow technology and/or geometrically. A portion of the channel located immediately next to this debouchment will also be referred to below as the proximal portion of the channel.

Since the inlet-side pre-distributing channel extends along the transverse direction of the bipolar plate, its advantageous function of “pre-distributing” inflowing coolant in this transverse direction is obtained. Immediately after the coolant enters the channel, that is to say in the proximal portion of the latter, this coolant is more or less “channeled” in the transverse direction, i.e. a large part of the coolant flowing into the inlet-side pre-distributing channel from the inlet hole flows from the proximal portion essentially in the transverse direction toward the “more distal” portions of the channel.

That the pre-distributing channels extend in the transverse direction is not intended to exclude the possibility that these channels run at an angle with respect to the transverse direction at least in portions, so long as such angles are less than 45°.

Since a plurality of, in particular for example at least 5, preferentially for example at least 10, throttle apertures arranged distributed along the profile of the inlet-side pre-distributing channel and facing toward the flow field are provided, a part of the coolant flowing in the respective region of the channel can enter said remaining part of the inlet-side distribution region transversely with respect to the profile of the channel, that is to say essentially in the longitudinal direction, in the region of each of these throttle apertures.

In summary, pre-distribution of the coolant in the transverse direction may thus take place on the inlet side by means of the pre-distributing channel, the pre-distributed coolant leaving the channel again in the longitudinal direction through the throttle apertures arranged distributed in the transverse direction, for example before the coolant has yet “advanced” particularly far as seen in the longitudinal direction of the bipolar plate.

A desired pre-distribution, which is generally as uniform as possible, of the inflowing coolant may particularly advantageously be achieved with high precision by corresponding dimensioning of the channel cross section and selection of the number, arrangement and cross sections of the throttle apertures.

In one embodiment, there is an “averaged position”, as seen in the longitudinal direction of the bipolar plate, of the positions of the throttle apertures of a pre-distributing channel within that half of the extent, as seen in the longitudinal direction of the bipolar plate, of the relevant distribution region that faces toward the assigned hole.

The same applies, as it were only with a reversed coolant flow, for the outlet-side distribution region, which could also be referred to as a “collection region” (since the coolant distributed in the transverse direction leaving the flow field is concentrated, or collected, here in cross section) and the outlet-side pre-distributing channel arranged therein, which in view of the reversed coolant flow could also be referred to as a “recollection channel”.

The integration, provided according to an aspect of the invention on the inlet side and outlet side, of a respective channel with throttle apertures in the respective distribution region of the bipolar plate allows in particular, for example, an outstandingly uniform flow distribution of the coolant during the flow through the flow space formed for the coolant between the two half-plates of the bipolar plate in the region of the “flow field”, that is to say the region as seen in the plane of the bipolar plate in which the electrochemical reaction for energy conversion takes place during operation of the fuel cells.

The respectively assigned pre-distributing channels may also each extend starting from the respective hole either “one-branched” only in one direction (orientation) or “two-branched” in both directions (orientations) in the transverse direction of the bipolar plate, depending on the specific arrangement of the holes for the coolant on the first and second edges of the bipolar plate, for example centrally or off-center or entirely at one end of the relevant edge. Depending on which is the case, one or two “branches” of the channel that extend in the transverse direction run starting from the proximal portion of the channel as far as the (one) distal end portion or the (two) distal end portions of the channel.

In one embodiment of the invention, the two half-plates connected to one another, and therefore also the bipolar plate, have an at least approximately rectangular format, whether for instance square or elongated. Furthermore, for example, an at least approximately polygonal format with more than four sides may however also be provided.

In the case of an elongated, for example at least approximately rectangular format, it is usually favorable for the mutually opposite first and second edges of the bipolar plate that extend in the aforementioned “transverse direction” to constitute the shorter sides of this format, while the remaining sides of this format (for example mutually opposite third and fourth sides in the case of a rectangle) extend in the aforementioned “longitudinal direction”.

The flow field of the bipolar plate is preferentially formed at a center of an area of the bipolar plate and may, for example, have an at least approximately rectangular format, whether for instance square or elongated. In the case of an elongated format, it is usually favorable for the corresponding longitudinal direction of the flow field to correspond to the longitudinal direction of the bipolar plate.

In one embodiment, the half-plates are each formed from a material of even thickness, in particular for example from a metal material, with a respective corrugation, for example by a shaping process in a press, so that the shape of the flow space between the half-plates is defined by these corrugations of the half-plates.

Furthermore, the flow space may also be defined additionally by, for example, seals placed between the half-plates and/or seals dispensed on at least one of the half-plates before the half-plates are connected to one another.

In one embodiment, the holes of the bipolar plate which are intended for the inlet and outlet of the coolant, as seen in the transverse direction of the bipolar plate, each occupy less than 50%, in particular less than 30%, of the width of the bipolar plate that is available in the transverse direction.

Further holes may be arranged beside these holes as seen in the transverse direction of the bipolar plate, through which the fuel (for example hydrogen) flows into or out of the fuel channel structure formed on the outer side of the anode-side bipolar half-plate, and the oxidant (for example oxygen or air) flows into or out of the oxidant channel structure formed on the outer side of the cathode-side bipolar half-plate.

In one embodiment, the holes (for the inlet and the outlet) for the coolant are respectively the central holes of a respective row of three holes arranged successively in the transverse direction of the bipolar plate for fuel, coolant and oxidant, in which case the pre-distributing channels each have two branches that run away from the proximal channel portion in mutually opposite orientations of the transverse direction starting from the respective proximal channel portion.

In one embodiment, the half-plates have projections that protrude into the respective distribution regions and bear pairwise on one another, by which for example columns (for example round columns) and/or wall elements (for example plate-like wall elements) that extend orthogonally with respect to the plane of the bipolar plate (that is to say in the vertical direction) are formed in the respective distribution regions.

Such columns and/or wall elements may advantageously provide mechanical support of the half-plates on one another and better-defined flow guiding for the coolant in the distribution regions. Moreover, further “structure elements” may also be formed on the half-plates in the vicinity of the distribution regions, by means of which (for example in addition to their effect in the flow space) projections for mechanically supporting an electrolyte membrane of the relevant fuel cell of the future fuel cell stack are formed on an opposite side of the relevant half-plate from the flow space.

In one development of this embodiment, at least some of the columns and/or plate-like wall elements form a row that runs along the profile of the respective pre-distributing channel on its side facing toward the flow field, so that intermediate spaces remaining between the columns or wall elements along the profile of the row form the throttle apertures of the respective pre-distributing channel.

In particular, the aforementioned row may be formed at least in portions only from plate-like wall elements, and these plate-like wall elements may respectively be oriented for example (and preferentially) parallel to the profile of the respective pre-distributing channel.

According to one embodiment, the throttle apertures in a proximal portion (as seen from the assigned hole) of the pre-distributing channel have a smaller cross section (and therefore greater flow resistance) than the throttle apertures in a distal end portion of the pre-distributing channel as seen from the assigned hole (whether the end portion of a “one-branched” pre-distributing channel or at least one of the two end portions of a “two-branched” pre-distributing channel). For this purpose, for example, in the aforementioned row of columns and/or plate-like wall elements, the inner spacings of the latter may be less in the proximal portion than in the distal end portion.

According to one embodiment, the throttle apertures in a proximal portion of the pre-distributing channel have a larger mutual spacing from one another than the throttle apertures in a distal end portion of the pre-distributing channel. For this purpose, for example, in the aforementioned row of plate-like wall elements, the lengths of the latter as seen in the extent direction of the channel may be greater in the proximal portion than in the distal end portion.

In one embodiment, the flow field is delimited on at least one of the half-plates by flow field channels running rectilinearly parallel to one another in the longitudinal direction of the bipolar plate. Alternatively or in addition, the flow field may be delimited on at least one of the half-plates for example by flow field channels running undulatingly parallel to one another in the longitudinal direction.

In one embodiment, a fuel channel structure formed on the outer side of the future anode-side bipolar half-plate for guiding the fuel through the relevant fuel cell in the region of the flow field of the bipolar plate is delimited by a multiplicity of (for example at least 20, in particular at least 40) flow field channels running rectilinearly parallel to one another in the longitudinal direction of the bipolar plate.

In one embodiment, an oxidant channel structure formed on the outer side of the future cathode-side bipolar half-plate for guiding the oxidant through the relevant fuel cell in the region of the flow field of the bipolar plate is delimited by a multiplicity of (for example at least 20, in particular at least 40) flow field channels running undulatingly parallel to one another in the longitudinal direction of the bipolar plate.

In one embodiment, the pre-distributing channels, as seen in the transverse direction of the bipolar plate, each occupy more than 60%, in particular more than 80%, of the width of the bipolar plate as seen in the transverse direction.

In particular, for example, the pre-distributing channels may in this case each occupy substantially the entire width of the bipolar plate or at least substantially the entire width of the assigned end of the flow field, so that the “pre-distribution” of the coolant takes place over the entire width of the flow field.

However, this does not exclude the possibility that the pre-distribution does not take place over almost the entire width of the bipolar plate, or flow field, that is to say for example a fraction of this width, for example less than 20% or for example less than 10% of the width of the bipolar plate, is provided “without pre-distribution” of the coolant. In this case, the coolant may still be distributed at the relevant locations by the respective remaining parts of the relevant distribution region before it enters the flow field. The same applies (with a reversed coolant flow) for the region of the bipolar plate on the outlet side.

In one embodiment, the pre-distributing channels have a width as seen in the plane of the bipolar plate and transversely with respect to their extent direction and a height as seen orthogonally with respect to this plane, their width being greater than their height over a majority of their profile.

In particular, this width may be greater than the height by at least a factor of 1.5, in particular at least a factor of 2, over a majority of the profile of the pre-distributing channel.

For example, this embodiment advantageously takes into account the fact that on the one hand the pre-distributing channel should have a relatively small flow resistance (and therefore a relatively large cross section) in order to fulfill its function, but on the other hand a maximum height at each location of the flow space between the two half-plates of a bipolar plate is more or less greatly limited in practice since a general aim in the design of fuel cell stacks is generally (also) to configure the sack as compactly as possible (i.e. to make the individual fuel cells relatively thin).

In one embodiment, as seen in the plane of the bipolar plate, the pre-distributing channels each occupy an area that is at least 5%, in particular at least 10%, and/or at most 40%, in particular at most 30%, of the area of the respective distribution region.

For example, this embodiment advantageously takes into account the fact that particularly precise coolant distribution in the flow field usually requires both the pre-distributing channel provided according to the invention, together with the throttle apertures arranged distributed along the profile of the latter, and a remaining part of a conventional distribution region (known from the prior art), in order to more “finely distribute” the coolant emerging pre-distributed at the “discrete” locations (of the throttle apertures) from the pre-distributing channel in the direction of the flow field, before it reaches the flow field. The same applies (with a reversed coolant flow) for the region of the bipolar plate on the outlet side.

A further aspect of the invention provides a fuel cell stack which comprises a plurality of bipolar plates of the type described here. In a manner known per se, the bipolar plates may be used as “separator plates” between mutually adjacent fuel cells of the stack (as described for example in the introduction).

### BRIEF DESCRIPTION OF THE DRAWINGS

Aspects of the invention will be described in more detail below with the aid of exemplary embodiments with reference to the appended drawings, in which:

FIG. 1 shows a schematic plan view of a bipolar plate according to one exemplary embodiment,

FIG. 2 shows a plan view of a first of two half-plates for the manufacture of a bipolar plate according to one exemplary embodiment,

FIG. 3 shows a plan view of the half-plate of FIG. 2 seen from the other side,

FIG. 4 shows a plan view of an associated second of the two half-plates,

FIG. 5 shows a plan view of the half-plate of FIG. 4 seen from the other side,

FIG. 6 shows a detail of FIG. 2,

FIG. 7 shows a detail of FIG. 4, and

FIG. 8 shows a perspective partially cutaway view of a bipolar plate manufactured from the half-plates of FIG. 2 to 7.

### DETAILED DESCRIPTION OF EXEMPLARY EMBODIMENTS

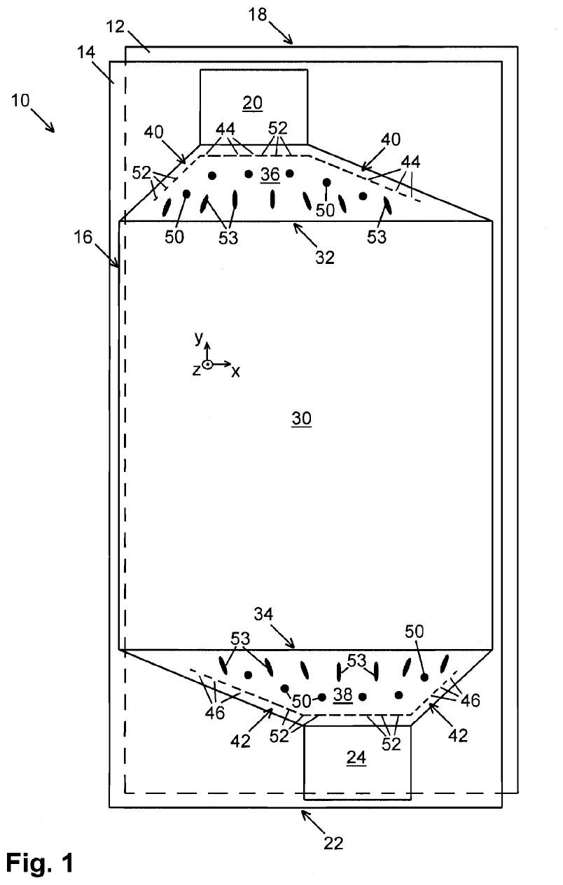

FIG. 1 shows a highly schematized representation of one exemplary embodiment of a bipolar plate 10 for a fuel cell stack.

A corresponding fuel cell stack contains inter alia a multiplicity of such bipolar plates 10, which are arranged stacked in the stack in a stack direction “z” and each of which has a plate-shaped geometrical configuration and therefore each of which extends, as seen orthogonally with respect to the stack direction z, in a first transverse direction “x” and a second transverse direction “y” orthogonal thereto.

The bipolar plate 10 comprises two metallic half-plates 12, 14 prefabricated by a respective shaping and stamping process and then connected to one another in places by welding (for example laser welding).

Formed between the half-plates 12, 14, there is a flow space 16 that is used to distribute a coolant which flows into the flow space 16 through an inlet hole 20, which is located on a first edge 18 of the bipolar plate 10, and flows out of the flow space 16 through an outlet hole 24, which is located on an opposite second edge 22 of the bipolar plate 10, over the area of a flow field 30 of the bipolar plate 10.

In the representation of FIG. 1, the first and second transverse directions x, y indicated are selected so that the first and second edges 18, 22 run in the x direction and these two (mutually opposite) edges 18, 22 are spaced apart from one another in the y direction.

For the sake of simplicity in what follows, the direction of the profile of the edges 18, 22, that is to say the x direction, will be referred to as the “transverse direction” x and the y direction orthogonal thereto in the plane of the bipolar plate 10 will be referred to as the “longitudinal direction” y of the bipolar plate 10. The z direction orthogonal to the plane of the bipolar plate 10 corresponds to the future stack direction (of the fuel cell stack) and will be referred to below as the “vertical direction” Z.

The configuration of the flow space 16 is based in this example on the two half-plates 12, 14 each having been provided with a respective corrugation during their prefabrication from a metal foil with an even thickness by the aforementioned shaping process in a press. After the welding of the half-plates 12, 14, there is a three-dimensional shape of the flow space 16 in the interior of the bipolar plate 10, which is defined by these corrugations.

By the stamping process carried out before or after the shaping of the half-plates 12, 14, the holes 20, 24 and further holes (not indicated in FIG. 1 for the sake of simplicity of the representation) for a fuel (here for example hydrogen) and an oxidant (here for example air) were formed.

The flow field 30 debouches at its ends 32, 34 facing toward the first and second edges 18, 22 of the bipolar plate 10 into a distribution region 36, 38, which is in turn connected to the respective hole 20, 24. Each distribution region 36, 38 therefore constitutes a subregion of the flow space 16, which is arranged between on the one hand the assigned hole (inlet hole 20 or outlet hole 24) and on the other hand the flow field 30.

One characteristic feature of the bipolar plate 10 is that the distribution region 36, 38 comprises a pre-distributing channel 40, 42, which debouches into the respective hole 20, 24, extends along the transverse direction x of the bipolar plate 10 and has along its profile a plurality of throttle apertures 44, 46 that are arranged distributed and face toward the flow field 30.

Each of the pre-distributing channels 40, 42 has, starting from a proximal portion of the respective pre-distributing channel 40, 42, which is immediately next to the respective hole 20, 24, two “branches” which extend in FIG. 1 to the left and to the right in the transverse direction x as far as the respective distal end portions of the channel. In this example, the proximal portion runs exactly in the transverse direction x, while the two branches of the channel respectively run with an inclination with respect to the transverse direction x.

In the example represented, the holes 20, 24 each occupy as seen in the transverse direction x about 30% of the total width of the bipolar plate 10 available in the transverse direction x in the region of the holes 20, 24.

The half-plates 12, 14 have projections that protrude (in the vertical direction z) into the respective distribution regions 36, 38 and bear pairwise on one another, by which columns 50, for example with a round or annular cross section in the x-y plane, and plate-like wall elements 52 with an ovally elongated cross section in the x-y plane, which extend in the vertical direction z are formed in the respective distribution regions 36, 38. Moreover, FIG. 1 indicates structure elements 53 which have a twofold function, namely on the one hand they can form columns with an annular cross section in the respective distribution regions 36, 38, and on the other hand they form projections on an opposite side of the relevant half-plates 12, 14 from the flow space 16 for mechanically supporting an electrolyte membrane of the relevant fuel cell in the future fuel cell stack.

The plate-like wall elements 52 indicated in FIG. 1 form a row that runs along the profile of the respective pre-distributing channel 40, 42 on its side facing toward the flow field 30, so that intermediate spaces remaining between the wall elements 52 along the profile of the row form the throttle apertures 44, 46 of the respective pre-distributing channel 40, 42. As represented in FIG. 1, these plate-like wall elements 52 are particularly advantageously each oriented parallel to the profile of the respective pre-distributing channel 40, 42.

According to one embodiment of the invention, the throttle apertures (for example their midpoints) in a proximal portion of the pre-distributing channel have a larger mutual spacing from one another than the throttle apertures in a distal end portion of the pre-distributing channel. In this case or for this purpose, for example, in the aforementioned row of plate-like wall elements, the lengths of the latter as seen in the extent direction of the channel may be greater in the proximal portion than in the distal end portion (for example, the latter is the case in the example of FIG. 1).

The cooling, or thermal regulation, of the bipolar plate 10 during its operation in a fuel cell stack functions as follows:

The bipolar plate 10 is supplied continuously through the inlet hole 20 with a coolant, which enters the inlet-side pre-distributing channel 40 that is in fluidic communication with the hole 20. Because of a relatively large cross section (and therefore relatively low flow resistance) of the pre-distributing channel 40, a majority of the coolant flowing into the channel 40 then flows first inside the channel 40 extending in the transverse direction x, that is to say in FIG. 1 substantially to the left and to the right starting from the entry point. However, only a part of this coolant reaches a respective end of the two “branches” of the channel 40, which run to the left and to the right in FIG. 1, since the throttle apertures 44 facing toward the flow field 30, of which there are for example twenty in FIG. 1, are formed along the channel 40, and a part of the coolant flowing in the respective region in the channel 40 enters through each of them orthogonally with respect to the profile of the channel 40 there into a remaining part of the inlet-side distribution region 36. In this part of the distribution region 36, the coolant flows further downward in FIG. 1 as far as the inlet-side end 32 (intake end) of the flow field 30, the columns 50 and structure elements 53 arranged there advantageously contributing to further homogenization of the distribution, as seen in the transverse direction x, of the flow rate of the coolant flowing substantially in the longitudinal direction y (downward in FIG. 1). There is therefore advantageously a distribution of the inflowing coolant, by which in the example represented coolant enters the multiplicity of “channel structure entries” located in the region of the end 32 with a substantially identical flow rate, and accordingly also emerges again from the multiplicity of “channel structure exits” located in the region of the end 34 (output end) with a substantially identical flow rate. The same applies (taking into account the as it were reversed regions through which the coolant flows) for the further flow of the coolant through the outlet-side distribution region 38, further through the outlet-side throttle apertures 46 into the outlet-side pre-distributing channel 42 and further into the outlet hole 24.

The flow field 30 of the bipolar plate 10 represented is formed at a center of the area of the bipolar plate 10 and has a rectangular format, the longer sides of which run in the longitudinal direction y of the bipolar plate 10.

This flow field 30 (not represented in detail in FIG. 1) is delimited on the two half-plates 12, 14 respectively by a flow field channel structure running in the longitudinal direction y, the geometrical configuration of which in the example represented corresponds to the “reverse” of the flow field channel structure formed on the outer sides (facing away from the flow region 16) of the respective half-plates 12 or 14 for the fuel (half-plate 12) and for the oxidant (half-plate 14). In the example, the flow field 30 is delimited in the case of the half-plate 12 by flow field channels running rectilinearly parallel to one another in the longitudinal direction y of the bipolar plate 10 and in the case of the half-plate 14 by flow field channels running undulatingly parallel to one another in the longitudinal direction y.

In the example represented, the pre-distributing channels 40, 42 each occupy as seen in the transverse direction x only about 65% of the width of the bipolar plate 10 available in the transverse direction x. The “pre-distribution” of the coolant thus takes place over this fraction of the width of the bipolar plate 10. “Post-distribution” of the coolant over the entire width in the transverse direction x as far as the corresponding end 32, 34 of the flow field 30 is carried out in this case by the remaining part of the corresponding distribution region 36, 38 not occupied by the pre-distributing channel 40, 42. In contrast to the example represented in FIG. 1, in the context of an aspect of the invention it is however usually preferred for the pre-distributing channels 40, 42 to each occupy almost the entire width of the bipolar plate, or at least almost the entire width of the flow field. In particular, the width of extent of the pre-distributing channels 40, 42 may for example be more than 80%, in particular for example at least 90%, of the width of the bipolar plate 10.

Moreover, in the example represented, as seen in the x-y plane of the bipolar plate 10, the pre-distributing channels 40, 42 each occupy an area that is about 10% of the area of the respective distribution region 36, 38.

In the following description of further exemplary embodiments of half-plates, or of a bipolar plate formed therefrom, the same reference signs are used for components that have the same effect. Essentially only the differences from the exemplary embodiment or embodiments already described will be discussed, and in other regards reference is explicitly made to the description of preceding exemplary embodiments.

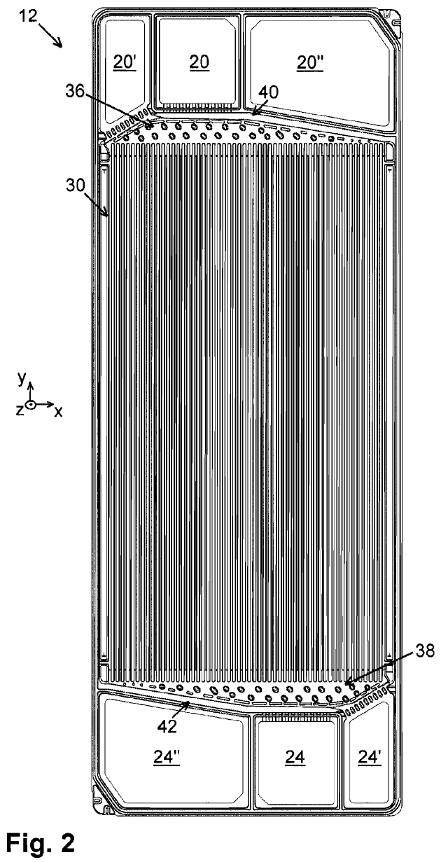

FIG. 2 to 5 show plan views of two half-plates 12, 14 for the manufacture of a bipolar plate 10 according to a further exemplary embodiment.

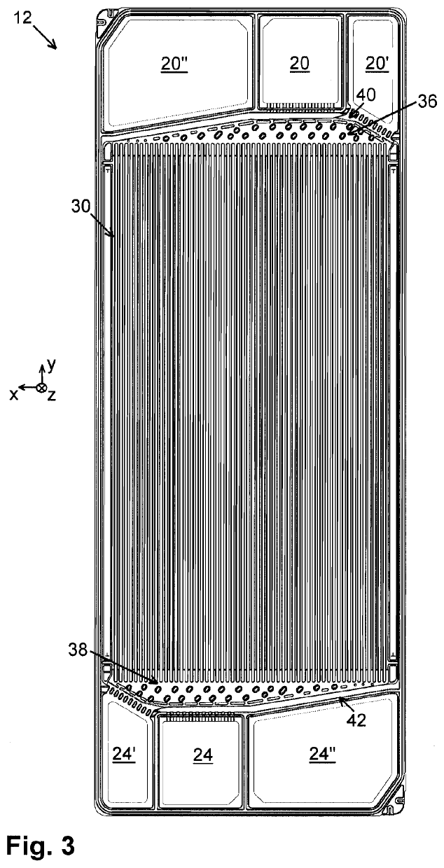

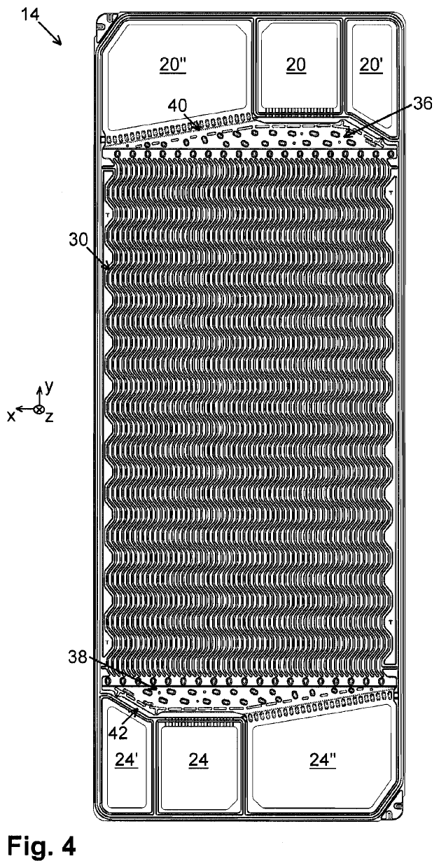

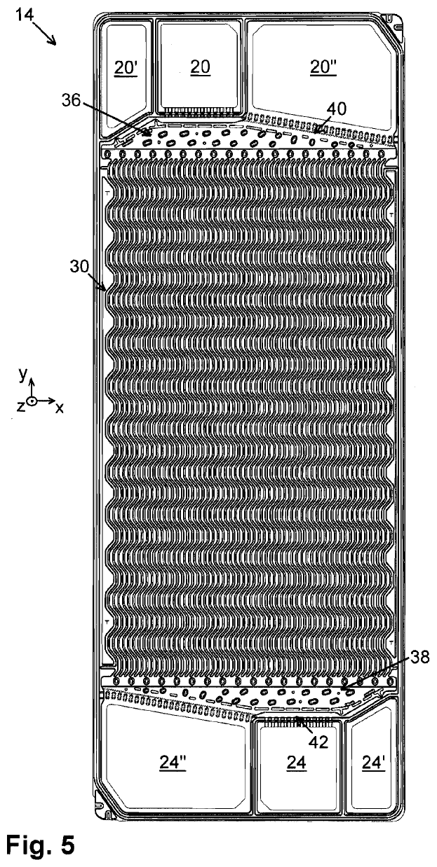

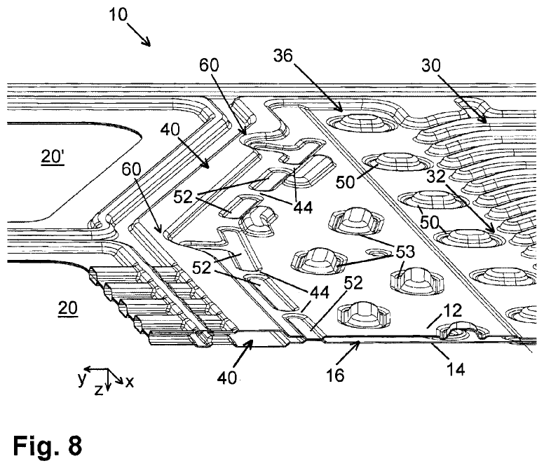

The first half-plate 12 represented in FIGS. 2 and 3 is provided as the anode-side half-plate of a bipolar plate 10 manufactured therewith (cf. FIG. 8), and the second half-plate 14 represented in FIGS. 4 and 5 is provided as the cathode-side half-plate of the bipolar plate 10.

FIGS. 3 and 5 show the “outer sides” of the half-plates 12, 14, on which a fuel channel structure (FIG. 3, half-plate 12) for guiding the fuel and an oxidant channel structure (FIG. 5, half-plate 14) for guiding the oxidant are respectively formed.

FIGS. 2 and 4 show the “inner sides” of the half-plates 12, 14, on which the guiding of the coolant through the interior of the bipolar plate 10 formed from the half-plates 12, 14 is provided.

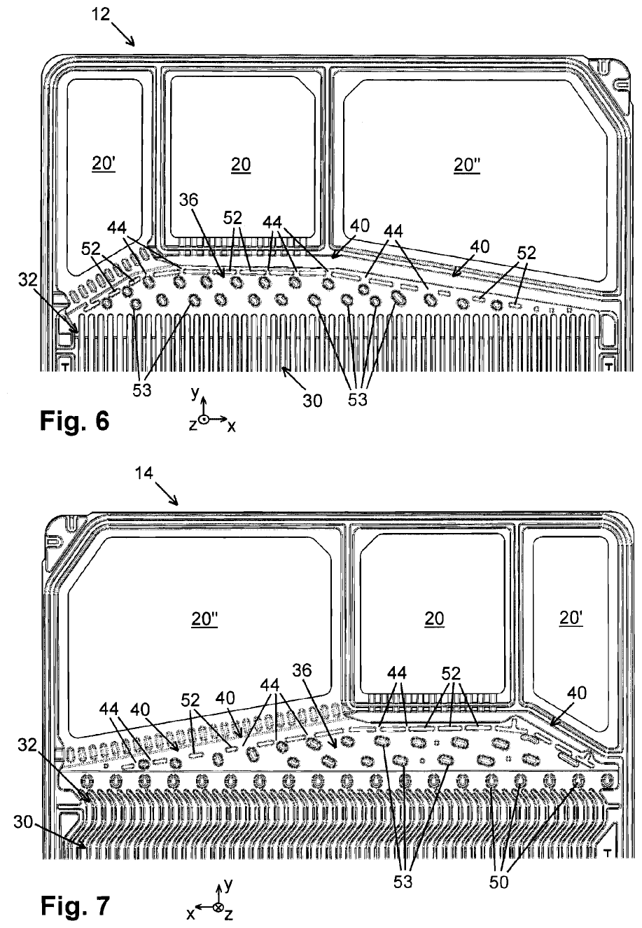

The configuration according to an aspect of the invention of this bipolar plate 10 may be seen more clearly from FIGS. 6 and 7, which respectively show on an enlarged scale details of FIGS. 2 and 4, as well as FIG. 8, which shows a perspective partially cutaway view of a detail of the bipolar plate 10.

In respect of the structure and function of the bipolar plate 10 (FIG. 8) manufactured from the half-plates 12, 14 (FIG. 2 to 7), reference is made to the explanations of the example of FIG. 1.

In the example of the bipolar plate 10 of FIG. 8, the pre-distributing channels 40, 42 advantageously each occupy substantially the entire width of the corresponding end 32, 34 of the flow field 30.

The example of FIG. 8 furthermore illustrates, for example, the advantageous characteristic according to which, over a majority of the profile of the pre-distributing channels 40, 42, their width is greater than their height. In the section plane which may be seen in FIG. 8, the width of the pre-distributing channel 40 is greater than its height by about a factor of 3 at this location. In the example represented, this said height moreover has a value that is not exceeded at any other location of the area of the bipolar plate 10. In other words, this value thus corresponds to a “maximum height” of the flow space 16 formed between the half-plates 12, 14. Both measures are advantageous in the context of an aspect of the invention insofar as they contribute to minimizing the flow resistance of the pre-distributing channels 40, 42 (which are for example formed substantially mirror-symmetrically with respect to one another). The example of FIG. 8 furthermore shows a measure that is often advantageous in the context of an aspect of the invention, which consists in forming throttle apertures arranged distributed along the profile of the pre-distributing channel in an edge region of the pre-distributing channel, in which the height of the channel is reduced significantly (for example by a factor in the range of from 1.5 to 4) in comparison with the height in the central region of the channel (in the example of FIG. 8, this factor is about 3). Such a reduced-height edge region of the pre-distributing channel may be formed over a majority of the length of the channel, and in particular also over at least approximately its entire length.

The example of FIG. 8 furthermore shows a measure that is often advantageous in the context of an aspect of the invention, which consists in providing a cross-sectional narrowing at at least one location in the profile of the pre-distributing channels. Two such cross-sectional narrowings 60 may be seen in FIG. 8. In this way, irrespective of the arrangement and dimensioning of the throttle apertures 44, a further improved optimization of the flow of the coolant in the pre-distributing channels may be achieved in the sense of a desired “pre-distribution” of the coolant in the transverse direction x.

In one advantageous embodiment, the cross section at the location of such a cross-sectional narrowing (cf. cross-sectional narrowings 60 in FIG. 8) is reduced by at least a factor of 2 in relation to each of the two cross sections that the relevant pre-distributing channel has immediately next to the cross-sectional narrowing, and/or the cross-sectional narrowing is formed by a corresponding reduction of the width of the corresponding pre-distributing channel at the location of the narrowing. In the example represented in FIG. 8, the channel 40 has an even height over the entire length of its profile despite the cross-sectional narrowings 60 formed thereon.

In summary, an aspect of the invention and the described exemplary embodiments provide a bipolar plate 10 for use in a fuel cell stack, by means of which a particularly uniform distribution of the coolant over the area of the flow field 30, and in particular therefore particularly uniform cooling or thermal regulation of the fuel cell stack over its volume, may be achieved in particular even with a distribution region 36, 38 occupying relatively little area.

In a manner known per se, by means of an electrochemical reaction, the chemical energy of reaction of a continuously supplied fuel (for example hydrogen) and of a continuously supplied oxidant (for example oxygen or air) can be converted into electrical energy with the fuel cell stack formed in this way, the reactants of the electrochemical reaction, that is to say fuel and oxidant, being supplied on different sides of a membrane-electrode assembly inside each fuel cell, as seen in the stack direction, during operation of the fuel cells arranged in a series electrical circuit through the (electrically conductive) half-plates. For this purpose, the bipolar half-plates of each fuel cell are respectively to be configured on their sides facing toward the membrane-electrode assembly with a channel structure in order to introduce the fuel and the oxidant on the respective sides of the membrane-electrode assembly through these channel structures into a respective gas diffusion sheet adjacent there, and therefore through the respective gas diffusion sheet onto the respective electrode layer on the corresponding side of the electrolyte membrane. The electrode layers may, for example, be formed from a carbon material and, for example, coated or permeated with a suitable catalyst. The electrode layer on the fuel side forms an anode and the electrode layer on the oxidant side forms a cathode of the membrane-electrode assembly. The product of the electrochemical reaction taking place in the individual fuel cells, for example water, may be discharged through the fuel cell region that guides the oxidant (for example air).

### LIST OF REFERENCE SIGNS

bipolar plate
12 first half-plate (anode side)
14 second-half-plate (cathode side)
x transverse direction
y longitudinal direction
z vertical direction
16 flow field
18 first edge
20 inlet hole (for coolant)
20′ inlet hole (for fuel)
20″ inlet hole (for oxidant)
22 second edge
24 outlet hole (for coolant)
24′ outlet hole (for fuel)
24″ outlet hole (for oxidant)
30 flow field
32 first end (of the flow field)
34 second end (of the flow field)
36 distribution region (inlet side)
38 distribution region (outlet side)
40 pre-distributing channel (inlet side)
42 pre-distributing channel (outlet side)
44 throttle apertures (inlet side)
46 throttle apertures (outlet side)
50 columns
52 wall elements
53 structure elements
60 cross-sectional narrowings

1. A bipolar plate for a fuel cell stack, comprising two half-plates connected to one another and a flow space formed between the half-plates for distributing a coolant which flows into the flow space through an inlet hole of the bipolar plate, which is located on a first edge of the bipolar plate, and flows out of the flow space through an outlet hole of the bipolar plate, which is located on an opposite second edge of the bipolar plate, over the area of a flow field of the bipolar plate,
wherein the flow field debouches at its ends facing toward the first and second edges of the bipolar plate into a distribution region connected to the respective hole, and
wherein the distribution region comprises a pre-distributing channel, which debouches into the respective hole, extends along a direction of the first and second edges of the bipolar plate and has along its profile a plurality of throttle apertures that are arranged distributed and face toward the flow field.

2. The bipolar plate as claimed in claim 1, wherein the half-plates are each formed from a material of even thickness with a respective corrugation, so that the shape of the flow space between the half-plates is defined by these corrugations.

3. The bipolar plate as claimed in claim 1, wherein the holes, as seen in the direction of the first and second edges of the bipolar plate, each occupy less than 50%, in particular less than 30%, of the width of the bipolar plate that is available in this direction.

4. The bipolar plate (10) as claimed in claim 1, wherein the half-plates have projections that protrude into the respective distribution regions and bear pairwise on one another, by which columns and/or plate-like wall elements that extend orthogonally with respect to the plane of the bipolar plate are formed in the respective distribution regions.

5. The bipolar plate as claimed in claim 4, wherein at least some of the columns and/or plate-like wall elements form a row that runs along the profile of the respective pre-distributing channel on its side facing toward the flow field, so that intermediate spaces remaining between the columns or wall elements along the profile of the row form the throttle apertures of the respective pre-distributing channel.

6. The bipolar plate as claimed in claim 5, wherein the row is formed at least in portions only from plate-like wall elements and these plate-like wall elements are respectively oriented parallel to the profile of the respective pre-distributing channel.

7. The bipolar plate as claimed in claim 1, wherein the flow field is delimited on at least one of the half-plates by flow field channels running rectilinearly parallel to one another in a direction orthogonal to the first and second edges of the bipolar plate and/or is delimited on at least one of the half-plates by flow field channels running undulatingly parallel to one another in this direction.

8. The bipolar plate as claimed in claim 1, wherein the pre-distributing channels, as seen in the direction of the first and second edges of the bipolar plate, each occupy more than 60%, in particular more than 80%, of the width of the bipolar plate as seen in this direction.

9. The bipolar plate as claimed in claim 1, wherein the pre-distributing channels have a width as seen in the plane of the bipolar plate and transversely with respect to their extent direction and a height as seen orthogonally with respect to this plane, and wherein their width is greater than their height over a majority of their profile.

10. The bipolar plate as claimed in claim 1, wherein, as seen in the plane of the bipolar plate, the pre-distributing channels each occupy an area that is at least 5%, in particular at least 10%, and/or at most 40%, in particular at most 30%, of the area of the respective distribution region.

11. A fuel cell stack having a plurality of bipolar plates as claimed in claim 1.

12. The bipolar plate as claimed in claim 2, wherein the holes, as seen in the direction of the first and second edges of the bipolar plate, each occupy less than 50%, in particular less than 30%, of the width of the bipolar plate that is available in this direction.

13. The bipolar plate as claimed in claim 2, wherein the half-plates have projections that protrude into the respective distribution regions and bear pairwise on one another, by which columns and/or plate-like wall elements that extend orthogonally with respect to the plane of the bipolar plate are formed in the respective distribution regions.

14. The bipolar plate as claimed in claim 13, wherein at least some of the columns and/or plate-like wall elements form a row that runs along the profile of the respective pre-distributing channel on its side facing toward the flow field, so that intermediate spaces remaining between the columns or wall elements along the profile of the row form the throttle apertures of the respective pre-distributing channel.

15. The bipolar plate as claimed in claim 14, wherein the row is formed at least in portions only from plate-like wall elements and these plate-like wall elements are respectively oriented parallel to the profile of the respective pre-distributing channel.
